(19) United States
(12) Patent Application Publication
(10) Pub. No.: US 2005/0196209 A1
(43) Pub. Date: Sep. 8, 2005

(54) Image reading apparatus and document scanning method using the same

(75) Inventor: Hun-Myun Lyu, Daegu-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 11/036,368

(22) Filed: Jan. 18, 2005

(30) Foreign Application Priority Data
Mar. 8, 2004 (KR) 2004-15611

(51) Int. Cl. G03G 15/00

(52) U.S. Cl. 399/376

(57) ABSTRACT

An image reading apparatus having: a body case provided with a document platen; a scan unit positioned in the body case, the scan unit traveling in an auxiliary scanning direction of a document and scanning an image of the document; a home sensor positioned on the scan unit to sense a home position of the scan unit; and a scanning determination unit positioned on the body case to predetermine a scanning range of the document.

### CROSS-REFERENCE TO RELATED APPLICATIONS

This application claims the benefit of Korean Patent Application No. 2004-15611 filed on Mar. 8, 2004 in the Korean Intellectual Property Office, the disclosure of which is incorporated herein by reference.

### BACKGROUND OF THE INVENTION

1. Field of the Invention

The present invention relates to an image reading apparatus and a document scanning method using the same, and more particularly, to an image reading apparatus capable of minimizing a time necessary for scanning by scanning only a desired portion of a document corresponding to a predetermined scanning range, using a scanning determination unit that enables a user to preset a portion for scanning the document, and a document scanning method using the image reading apparatus.

2. Description of the Related Art

Office automation equipment, such as copiers, a facsimile machines, and MFPs (multi-function products), include an image reading apparatus reading an image of a document and converting it into data. Specifically, an image reading apparatus included in an MFP has a digital copying function to print and copy the image of the document that has been read. Such an image reading apparatus may be classified, according to a driving mode of a scan unit, namely: a flat bed type apparatus wherein the scan unit travels below the document; and a sheet feed type apparatus wherein the scan unit is fixed while the document travels.

FIG. 1 is a top plan view showing the construction of a conventional flat bed type image reading apparatus 100.

Referring to FIG. 1, a body case 200 is provided with a document platen 300 for placing a document on its surface. A scan unit 400 is positioned in the body case 200 for reading an image of the document. The scan unit 400 includes an image sensing unit sensing the image of the document, and a feed module (not shown in the drawing) to drive the image sensing unit. The image sensing unit may include a CCD (charge coupled device) module 410 or a CIS (contact image sensor) module. The scan unit 400 also includes a home sensor 420 determining a point of time to stop the scan unit 400 by detecting a home position rib 210, which is positioned on the body case 200.

A document scanning method of the scan unit 400 may be classified into: a scan range selection mode, wherein a scanning range, such as a letter size or an A4 size, is preset, and a document is scanned according to the setting; a special function mode wherein the entire range of a flat bed is pre-scanned to realize special functions, including an auto-fit function used to magnify a small image of the document so that it fits the paper size of a page and print the image, a clone copying function used to reduce the image of the document and clone-print multiple images on a paper; and a reduction/enlargement mode scanning the document only by a predetermined size from the largest readable point from the beginning regardless of the size of the document.

However, a conventional image reading apparatus 100 has the following problems regarding the document scanning method:

Firstly, in the case of the scan range selection mode, if a document is scanned when a scanning range is preset as a letter size (105 mm×241 mm) and the actual document is more than an A4 size (210 mm×297 m), data is inevitably divided, because any data that exists outside the letter size range is printed on the second page. Such a problem occurs when a user scans a document while he/she doesn't correctly recognize the preset scanning range. The user can correctly recognize the preset scanning range only after a few times of trial and error. This causes time loss.

Secondly, in the case of the special function mode, any foreign matter existing in the body case 200 or on the document platen 300when the document is pre-scanned may be misrecognized as data, and any unnecessary portion of the pre-scanned document may also be misrecognized as the data. This makes it difficult to obtain correct data. Specifically, when the auto-fit function or the clone copying function is employed, the entire range of the document should be scanned regardless of the document size, to ascertain the edge of the document correctly. This takes a lot of operation time.

Thirdly, in the case of the reduction/enlargement mode where the document is scanned regardless of its size, the entire data of the document should be outputted even when only a part of the document needs to be scanned. This also takes a lot of operation time.

Japanese Laid-Open Patent Application No. 2001-16406, entitled “IMAGE FORMING DEVICE AND IMAGE FORMING METHOD” (the disclosure of which is incorporated herein by reference) discloses an image reading apparatus adapted to scan a document after identifying a scanning width of the document in a main scanning direction and the size of the document in an auxiliary scanning direction.

In the Japanese patent application, a data reading unit, including a CCD module, reads data from a document in a main scanning direction, and a position detection unit detects a seated position and a width of the document in the main scanning direction from data inputted by the data reading unit. Furthermore, a size detection unit detects a size of the document in the auxiliary direction using values sensed by first and second photo-sensors.

According to the Japanese Application as mentioned above, the data reading unit could scan a detected area only by detecting a scanning width of the document in the main scanning direction and the size of the document in the auxiliary scanning direction. But first and second photo-sensors simply perform a function of detecting whether the document size is A3 size—A4 size or B4 size—B5 size. As a result, even when a user wants to scan only a part of the document, a range of the document corresponding to the detected size is unduly scanned. This lengthens operation time.

### SUMMARY OF THE INVENTION

Accordingly, the present invention has been made to solve the above-mentioned and/or other problems occurring in the document scanning method of a conventional image reading apparatus, and an aspect of the present invention is to provide an image reading apparatus capable of minimizing a time necessary for scanning by scanning only a desired part without any pre-scanning using a scanning determination unit that enables a user to preset a portion for scanning a document, and a document scanning method using the apparatus.

Another aspect of the present invention is to provide an image reading apparatus in which document scanning is performed under the situation of predetermining an exact scanning range in main and auxiliary scanning directions of the document, when performing a special function, such as an auto-fit function or a clone copying function, so that it is possible not only to obtain correct data but also to avoid error, and a document scanning method using the apparatus.

To accomplish these and/or other aspects, there is provided an image reading apparatus comprising: a body case provided with a document platen; a scan unit positioned in the body case, the scan unit traveling in an auxiliary scanning direction of a document and scanning an image of the document; a home sensor positioned on the scan unit to sense a home position of the scan unit; and a scanning determination unit positioned on the body case to predetermine a scanning range of the document.

According to one aspect, the scan unit includes a CCD module sensing the image of the document and a feed module moving the CCD module in the auxiliary scanning direction of the document.

According to one aspect, the scanning determination unit comprises a guide rail positioned directly below a traveling path of the scan unit; a movable body coupled to the guide rail so that the moving body moves according to the traveling path of the scan unit; a positioning rib included in the movable body to be sensed by the home sensor to determine a point to end scanning in the auxiliary scanning direction of the document; and a positioning body extending from the movable body and protruding from a portion of the body case.

According to one aspect, the body case comprises a user selection button to set an operation mode of the scanning determination unit.

According to one aspect, the positioning body is positioned along the auxiliary scanning direction of the document platen so that a user can set the point to end scanning of the document.

According to one aspect, the movable body comprises a first movable body to predetermine a point to start scanning of the scan unit, and a second movable body to predetermine a point to end scanning of the scan unit.

According to another aspect of the present invention, there is provided a document scanning method, which is implemented through the above image reading apparatus, comprising: a scanning determination operation of determining a point to end scanning in an auxiliary scanning direction of a document by moving a positioning body of a scanning determination unit corresponding to an actual scanning range of the document seated on a document platen; and a document scanning operation of scanning the document using a scan unit corresponding to the point to end scanning in the auxiliary scanning direction of the document.

According to one aspect, the scanning determination operation comprises an operation of moving a first positioning body of a first movable body and a second positioning body of a second movable body corresponding to the actual scanning range of the document seated on the document platen, to determine a point to start scanning and the point to end scanning in the auxiliary scanning direction of the document.

According to one aspect, in the document scanning operation, a point to start scanning in the auxiliary scanning direction of the document is determined based on a point when the scan unit has traveled a predetermined distance from a home position rib.

According to one aspect, the scanning determination operation further comprises an operation of setting a scanning setting mode with a user selection button.

According to one aspect, the scanning determination operation further comprises an operation of determining the scanning width in a main scanning direction of the document.

According to one aspect, in the operation of determining the scanning width in the main scanning direction of the document, the scanning width of the document is determined in a maximum scanning width in which the scan unit can perform scanning in the main scanning direction of the document.

According to one aspect, in the operation of determining the scanning width in the main scanning direction of the document, an edge surface of the document is scanned using the scan unit to determine the scanning width in the main scanning direction of the document.

According to one aspect, the scan unit travels within 20 mm from a point of time to start scanning in the auxiliary scanning direction of the document, to scan the edge surface of the document.

Additional aspects and/or advantages of the invention will be set forth in part in the description which follows, and in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a top plan view showing construction of a conventional flat bed type image reading apparatus;

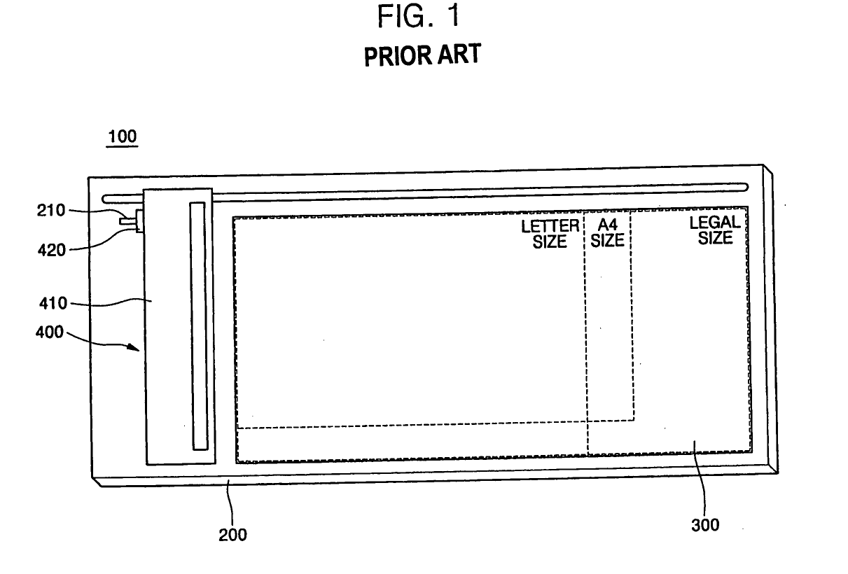

FIG. 2 is a top plan view showing construction of an image reading apparatus according to an embodiment of the present invention;

FIG. 3 is a perspective view illustrating a scanning determination unit included in an image reading apparatus according to the present invention;

FIG. 4A is a flow chart illustrating a document scanning method using the image reading apparatus of FIG. 1;

FIG. 4B is a top plan view illustrating operation of a scanning determination unit;

FIG. 4C is a timing diagram illustrating operation of a home sensor while employing a document scanning method according to an embodiment of the present invention;

FIG. 5 is a perspective view showing a scanning determination unit included in an image reading apparatus according to another embodiment of the present invention;

FIG. 6A is a flow chart illustrating a document scanning method using the image reading apparatus of FIG. 5;

FIG. 6B is a top plan view illustrating operation of a scanning determination unit of the image reading apparatus of FIG. 5; and

FIG. 6C is a timing diagram illustrating operation of a home sensor while employing a document scanning method according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described to explain the present invention by referring to the figures.

An image reading apparatus 1 according to an embodiment of the present invention is a flat bed type apparatus, in which a scan unit travels below a document. According to one embodiment, the apparatus is included in office automation equipment. According to another embodiment, the apparatus is provided as a separate device.

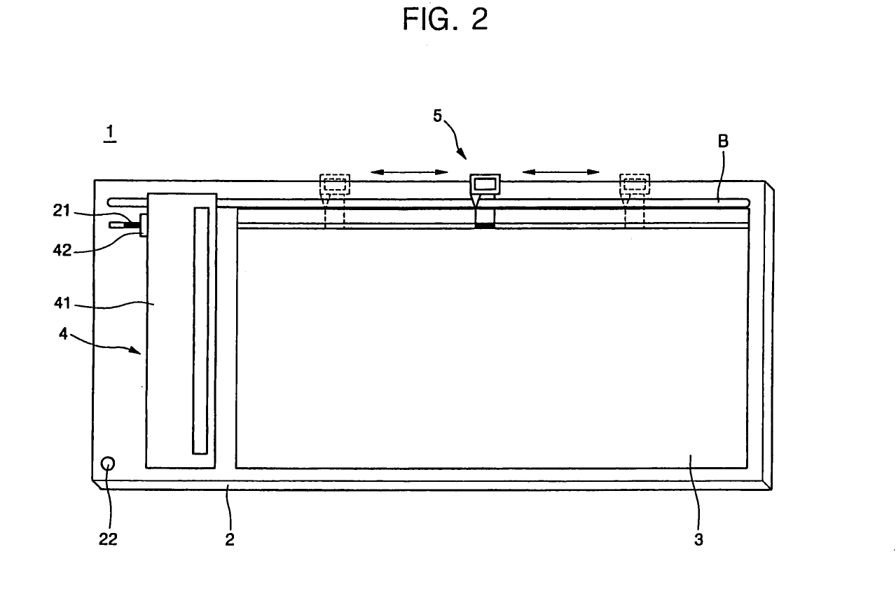

Referring to FIG. 2, a body case 2 includes a document platen 3 to place a document on an upper surface thereof, and a scan unit 4 positioned therein. The body case 2 further includes a cover (not shown in the drawing) retaining the document on the document platen 3, and an operation panel (not shown in the drawing) to apply a user's input to a central processing unit of the image reading apparatus 1. The scan unit 4 includes an image sensor sensing an image of the document, for example a CCD module 41, and a feed module (not shown in the drawing) driving the CCD module 41. According to one embodiment, the feed module includes a guide bar B guiding the CCD module 41 in an auxiliary scanning direction of the document, and a driving unit (not shown in the drawing) driving the CCD module 41. The scan unit 4 also includes a home sensor 42. The home sensor 42 senses a home position rib 21, which is located in a portion of the body case 2, for example in a home position of the CCD module 41, and generates a signal to determine a point at which to stop the CCD module 41.

According to the present embodiment, a scanning determination unit 5 is positioned in the body case 2 to predetermine an actual scanning range of the document.

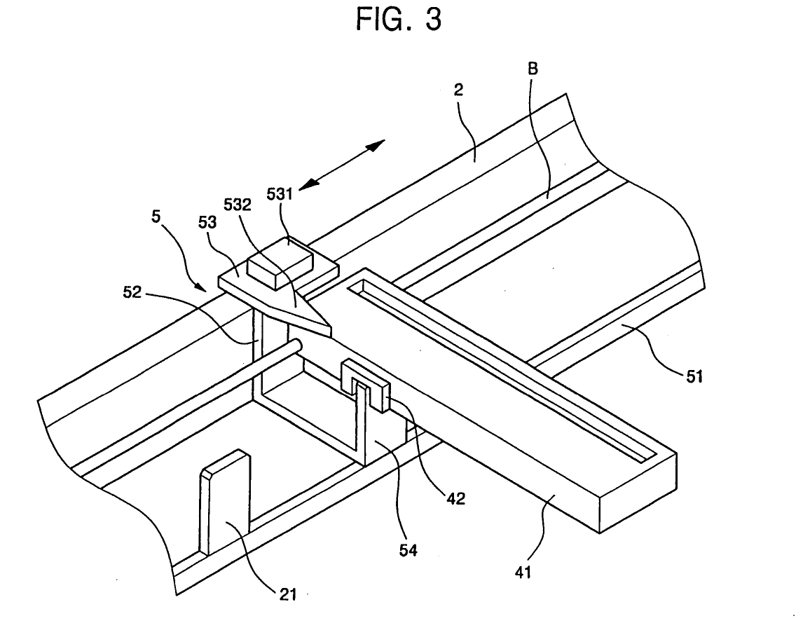

Referring to FIG. 3, the scanning determination unit 5 includes a guide rail 51 positioned directly below a traveling path of the scan unit 4, and a movable body 52 coupled to the guide rail 51. According to one embodiment, the guide rail 51 is configured, for example, in a form of a linear prominence or a linear bar, to guide the movable body 52 so that it can be moved in a sliding mode. According to the form of the guide rail 51, the movable body 52 may be seated on the guide rail 51 or coupled to the guide rail 51 via an additional guide member (not shown in the drawing) positioned on an end of the movable body 52.

The movable body 52 includes a positioning body 53 protruding from a portion of the body case 2, and a positioning rib 54 positioned on a horizontal line with the home position rib 21. The positioning body 53 is a guide to manually change a position of the movable body 52. According to one embodiment, the positioning body 53 is positioned on an upper side of the document platen 3, for example along an auxiliary scanning direction of the document. According to one embodiment, the positioning body 53 is provided with a handle-shaped prominence 531 which enables a user to easily grab and manipulate it, as well as an indicator 532 for indicating a scale. The body case 2 is provided with an incision (not shown in the drawing) so that the user can easily move the positioning body 53 manually. The incision is preferably provided with a seal (not shown in the drawing) to minimize penetration of a foreign substance into the body case 2.

The body case 2 further includes a user selection button 22 so that a user can selectively perform document scanning using the scanning determination unit 5. If the user presses the user selection button 22, the scanning is performed in a scanning selection mode using the scanning determination unit 5. Otherwise, the documents are scanned in a normal scanning method.

A document scanning method using the image reading apparatus 1 including the scanning determination unit 5 will now be described.

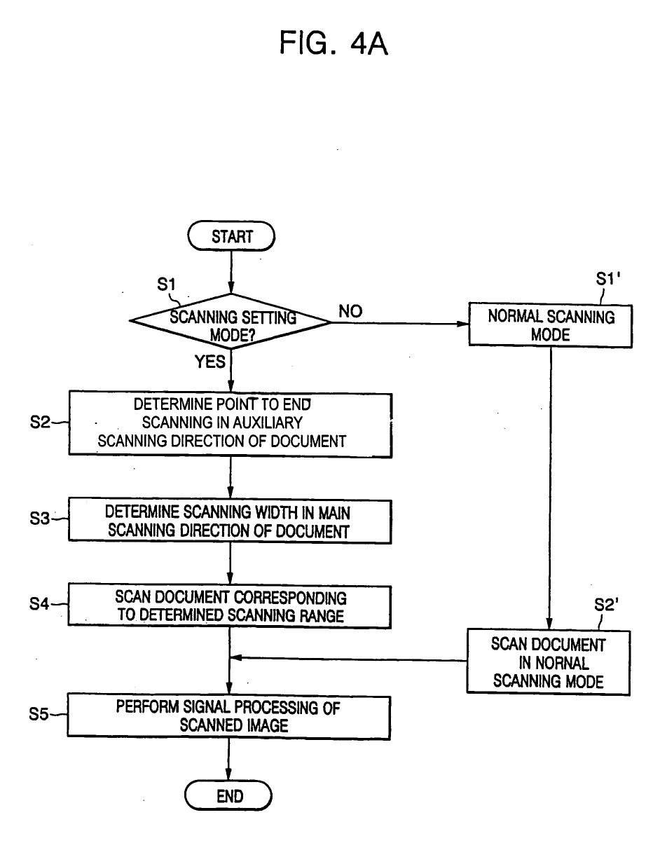

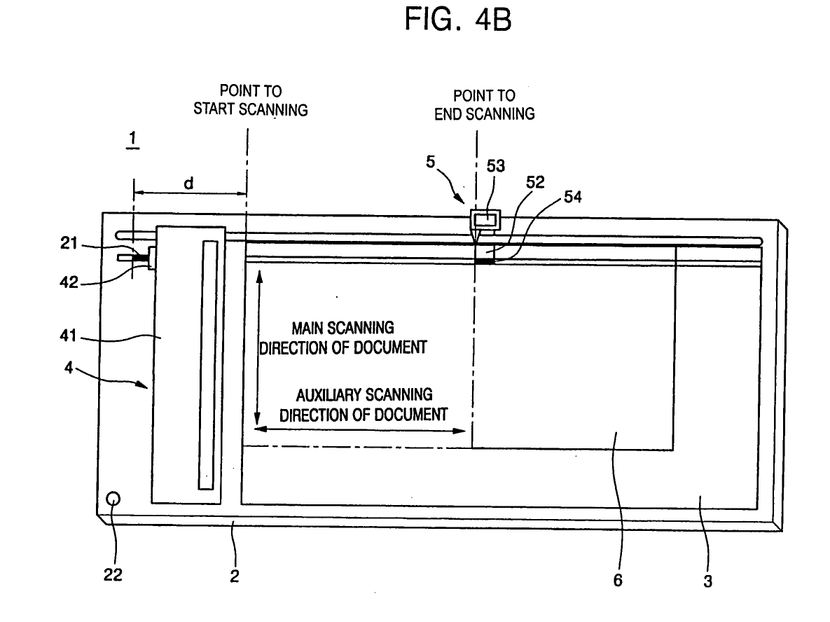

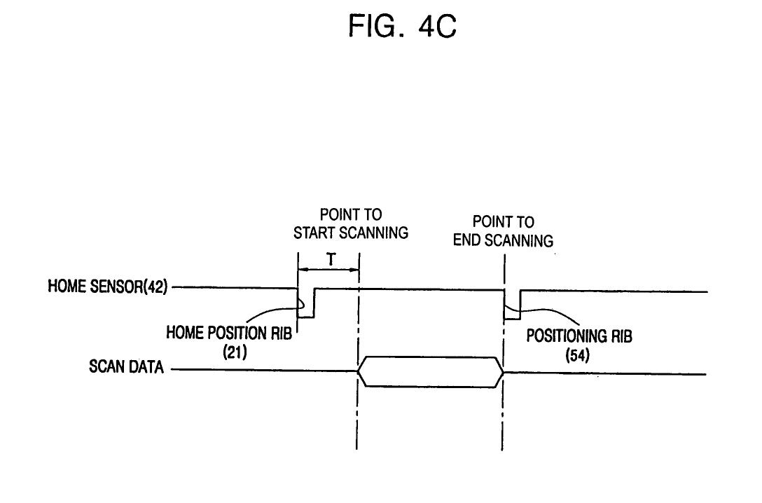

Referring to FIG. 4A, a scanning determination operation (S2) is performed where a document is seated on the document platen 3, the positioning body 53 of the scanning determination unit 5 is moved corresponding to an actual scanning range of the document, and a point to end scanning in an auxiliary scanning direction of the document is determined. The document scanning operation (S4) is performed where the document is scanned using the scan unit 4 corresponding to the predetermined point to end scanning in the auxiliary scanning direction of the document. Signal processing is performed to the image of the scanned document and document scanning is terminated (S5).

Here, the scanning determination operation (S2) may further include operation (S1) where a user presses the user selection button 22 to set the operation mode of the image reading apparatus 1 to a scanning setting mode, and operation (S3), determining a scanning width in a main scanning direction of the document. If the scanning width in the main scanning direction of the document is determined in such a way, then in the document scanning operation (S4), the document is scanned corresponding to the predetermined scanning width in the main scanning direction of the document and the point to end scanning in the auxiliary scanning direction. If the user doesn't press the user selection button 22, the operation mode of the image reading apparatus 1 is set to a normal scanning mode (S1′) and the document is scanned according to a normal document scanning method (S2′).

According to one embodiment, in the scanning determination operation (S2), a point to start scanning in the auxiliary scanning direction of the document is determined based on a a time interval during which the CCD module 41 of the scan unit 4 has traveled a predetermined distance d from the home position rib 21, as is shown in FIG. 4B. Specifically, the interval shown in FIG. 4C corresponds to a period of time T, during which a home sensor 42 has traveled the predetermined distance d from the home position rib 21 in an “ON” state. The period of time T can be calculated from a driving velocity of a motor included in a feed module and the distance d traveled by the home sensor 42 up to the point to start scanning. As a result, the point to start scanning in the auxiliary direction of document 6 may be predetermined by a traveling time of the scan unit 4 and displayed on an upper surface of the body case 2, specifically on an upper portion of a document platen 3, to be recognized by a user. Then, the user can visually determine a corresponding point to start scanning and seat the document 6 on the document platen 3.

The point to end scanning in the auxiliary scanning direction of the document 6 is determined by moving the positioning rib 54 of the scanning determination unit 5 corresponding to the actual scanning range of the document 6, as is shown in FIG. 4B. When the user wishes to perform such an operation to move the positioning rib 54, he/she manually moves the positioning body 53, which extends from the movable body 52, and positions the positioning rib 54, which is included in the movable body 52, corresponding to the point to end scanning of the document 6.

According to one embodiment, in the operation (S3) of determining the scanning width in the main scanning direction of the document, the CCD module 41 of the scan unit 4 scans the document in a maximum scanning width in which the CCD module 41 can perform scanning in the main scanning direction of the document. According to another embodiment, the CCD module 41 of the scan unit 4 moves in the auxiliary scanning direction of the document to scan the edge surface of the document 6 to predetermine the scanning width in the main scanning direction. In this case, the CCD module 41 of the scan unit 4 travels a predetermined distance in the auxiliary scanning direction of the document from the predetermined point to start scanning in the auxiliary scanning direction, and scans the edge surface of the document 6. If a scanning length, with which the CCD module 41 of the scan unit 4 scans the document, is set within 20 mm, sufficient information can be obtained on the edge surface of the document. The information on the edge surface is processed in a central processing unit of the image reading apparatus 1 to predetermine the scanning width of the document 6 in the main scanning direction.

In the document scanning operation (S4) where the document 6 is scanned using the scan unit 4, the scan unit 4 begins scanning in the auxiliary scanning direction from the point to start scanning, after the home sensor 41 is moved away from the home position rib 21. Regarding the scanning width in the main scanning direction of the document 6, the CCD module 41 of the scan unit 4 scans the document 6 in a maximum scanning width or in a scanning width predetermined by scanning the edge surface of the document 6. If the home sensor 42 senses the positioning rib 54 of the movable body 52, the document scanning is terminated and the CCD module 41 of the scan unit 4 returns to its home position, where the home position rib 21 is disposed.

Consequently, the document scanning method can shorten scanning time by scanning using the scan unit 4 in only a desired scanning range, which spans from the point to start scanning the document 6 to the point to end scanning, which is predetermined by the scanning determination unit 5.

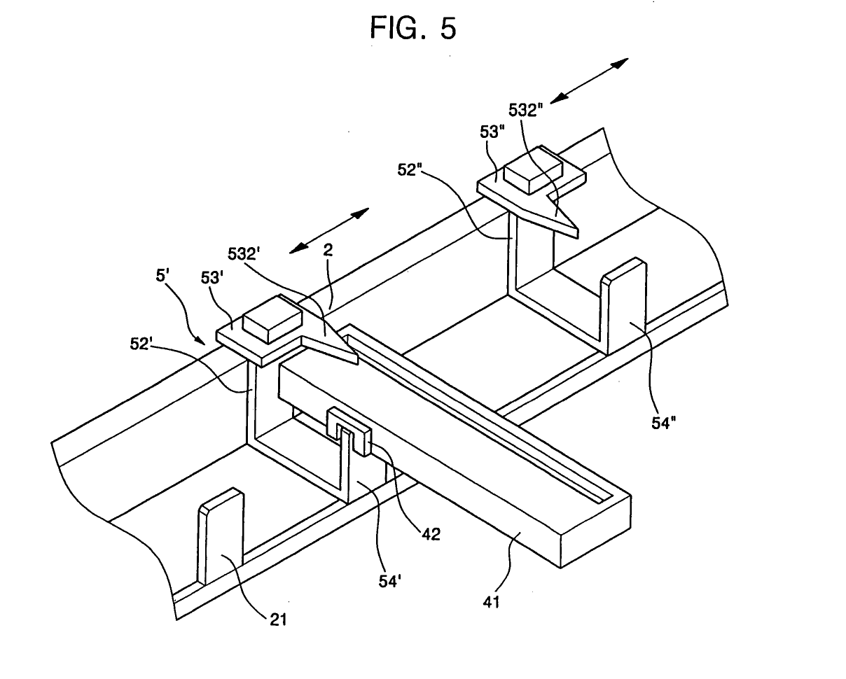

Referring to FIG. 5, a scanning determination unit 5′ according to a second embodiment of the present invention comprises a plurality of movable bodies, including a first movable body 52′ to determine a point to start scanning of the scan unit 4, and a second movable body 52″ to determine a point to end scanning of the scan unit 4. In this configuration, first and second positioning bodies 53′ and 53″, corresponding to the first and second movable bodies 52′ and 52″, respectively, are positioned on a horizontal line. Furthermore, a first and second positioning ribs 54′ and 54” are provided to be sensed by the home sensor 42.

The home sensor 42 generates signals to activate/deactivate the CCD module 41 in exact accordance with the points to start/end scanning, which a user has set by moving the first and second positioning bodies 53′ and 53″, to obtain an image of a desired scanning range. For this, positional relationship of the first and second positioning bodies 53′ and 53″ and the first and second positioning ribs 54′, 54″, which are included in the first and second movable bodies 52′ and 52″, as well as the width of the first and second positioning ribs 54′ and 54″, should be determined in consideration of a position where the home sensor 42 is mounted to the CCD module 41. According to one embodiment, when the home sensor 42 is positioned rearward of a lower surface of the CCD module 41, as is shown in FIG. 5, the first movable body 52′ synchronizes the point to activate the CDD module 41 with the point to start scanning by positioning a first indicator 532′ of the first positioning body 53′ with reference to the right end of the first positioning rib 54′. Similarly, the second movable body 52″ synchronizes the point to deactivate the CDD module 41 with the point to end scanning by positioning a second indicator 532″ of the second positioning body 53″ with reference to the left end of the second positioning rib 54″.

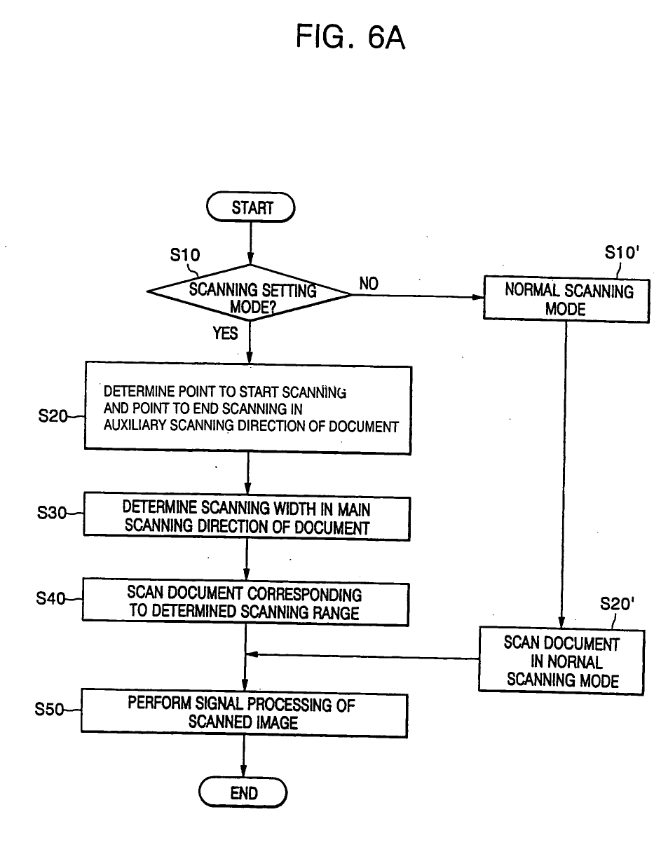

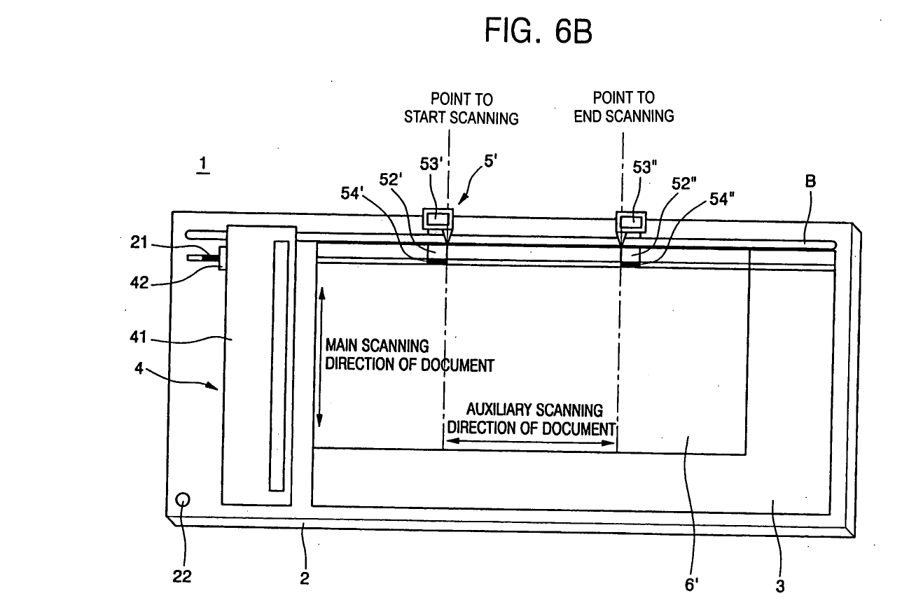

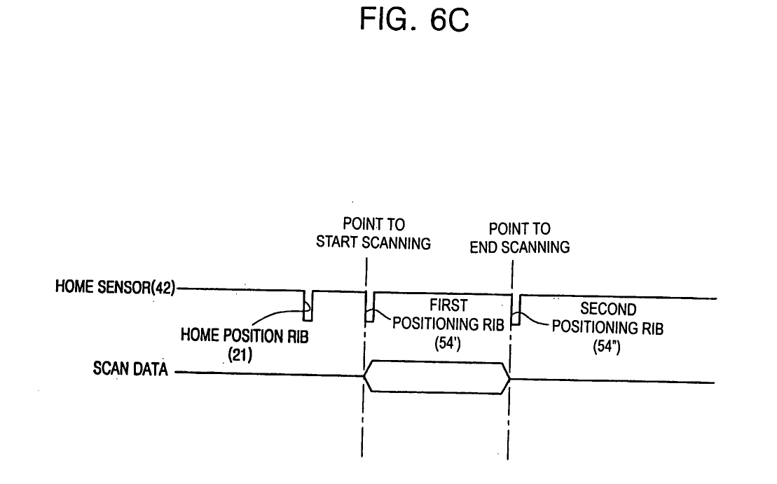

FIG. 6A is a flow chart illustrating a document scanning method using the image reading a apparatus 1 of FIG. 5. Referring to FIG. 6A, a scanning determination operation (S20) is performed where a point to start scanning and a point to end scanning in an auxiliary scanning direction of a document seated on the document platen 3 is predetermined by moving first and second movable bodies 52′ and 52″ of first and second positioning bodies 53′ and 53″, respectively, corresponding to an actual scanning range of the document 3. A document scanning operation (S40) is performed where the document is scanned using a scan unit 4 corresponding to the predetermined point to start scanning and the point to end scanning in the auxiliary scanning direction of the document. Additionally, signal processing is performed to the image of the scanned document, and document scanning method is terminated (S50).

According to one embodiment, the scanning determination operation (S20) includes an operation (S10), wherein a user presses the user selection button 22 to set the operation mode of the image reading apparatus to a scanning setting mode, and an operation (S30) of determining the scanning width in the main scanning direction of the document. If the scanning width in the main scanning direction of the document is determined in such a way, the document is scanned, in the document scanning operation (S40), using the scan unit 4, corresponding to the predetermined scanning width in the main scanning direction of the document, as well as the point to start scanning and the point to end scanning in the auxiliary scanning direction. If the user doesn't press the user selection button 22, the operation mode of the image reading apparatus is set to a normal scanning mode(S10′), and the document is scanned according to a normal document scanning method (S20′).

In the scanning determination operation (S20), each of the first and second positioning ribs 54′ and 54″ of the scanning determination unit 5′ is moved corresponding to an actual scanning range of the document, is shown in FIG. 6B. When the user needs to perform an operation to move each of the first and second positioning ribs 54′ and 54″, he/she manually moves the first positioning body 53′, which extends from the first movable body 52′, and positons the first positioning rib 54′, which is included in the first movable body 52′, corresponding to the point to start scanning of a document 6′. Then, he/she manually moves the second positioning body 53″, which extends from the second movable body 52″, and positions the second positioning rib 54″, which is included in the second movable body 52″, corresponding to the point to end scanning of the document 6′.

According to one embodiment, in the operation (S30) of determining the scanning width in the main scanning direction of the document, the CCD module 41 of the scan unit 4 scans the document in a maximum scanning width in which it can perform scanning in the main scanning direction of the document 6′, as mentioned above. According to another embodiment, the CCD module 41 of the scan unit 4 moves in the auxiliary scanning direction of the document to scan the edge surface of the document 6′, to determine the scanning width in the main scanning direction.

In this case, the CCD module 41 of the scan unit 4 travels a predetermined distance in the auxiliary scanning direction of the document 6′ from the point to start scanning in the auxiliary scanning direction and scans the edge surface of the document 6′. If a scanning length, with which the CCD module 41 of the scan unit 4 scans the document 6′, is set within 20 mm, sufficient information can be obtained on the edge surface of the document 6′. The information on the edge surface is processed in the central processing unit of the image reading apparatus 1, to determine the scanning width in the main scanning direction of the document 6′.

In the document scanning operation (S40), wherein the document 6′ is scanned using the scan unit 4, the scan unit 4 quickly travels, after the home sensor 42 has been moved away from the home position rib 21, without any operation until sensing the first positioning rib 54′ of the first movable body 52′, as is shown in FIG. 6C. When sensing the first positioning rib 54′, the scan unit 4 starts scanning the document 6′. Regarding the scanning width in the main scanning direction of the document 6′, the CCD module 41 of the scan unit 4 scans the document 6′ in a maximum scanning width, or in a scanning width predetermined by scanning the edge surface of the document. If the home sensor 42 of the scan unit 4 senses the second positioning rib 54″ of the second movable body 52″, which corresponds to the point to end scanning, the document scanning is terminated and the CCD module 41 of the scan unit 4 returns to its home position where the home position rib 21 is disposed.

Consequently, the document scanning method is useful when the user manually determines the point to start scanning and the point to end scanning in the auxiliary scanning direction of the document 6′, to scan only a central portion of the document 6′. The method can also minimize operation time by scanning only a desired range without any additional pre-scanning process.

Specifically, if the document 6′ is scanned after predetermining the scanning width in the main scanning direction of the document 6′ and the scanning range in the auxiliary scanning direction of the document 6′, it is possible to predetermine an exact scanning range when realizing a special copying function, such as auto-fit or clone copying. As a result, any pre-scanning can be avoided and correct data can be obtained.

As is mentioned above, the image reading apparatus 1 and the document scanning method using the apparatus 1 make it possible to minimize the time necessary for scanning, by scanning only the desired portion of a document without any pre-scanning, using the scanning determination unit 5, which enables the user to preset a portion to scan from the document.

In addition, it is possible to perform copying, magnification/reduction, auto-fit, and clone copying functions to a predetermined scanning range without any pre-scanning. In particular, it is possible to determine an exact scanning range in the main and auxiliary scanning directions of the document when realizing an auto-fit or clone copying function, thus preventing any error.

Although a few embodiments of the present invention have been shown and described, it would be appreciated by those skilled in the art that changes may be made in these embodiments without departing from the principles and spirit of the invention, the scope of which is defined in the claims and their equivalents.

1. An image reading apparatus comprising:
a body case provided with a document platen;
a scan unit positioned in the body case, the scan unit traveling in an auxiliary scanning direction of a document and scanning an image of the document;
a home sensor positioned on the scan unit to sense a home position of the scan unit; and
a scanning determination unit positioned on the body case to predetermine a scanning range of the document.

2. The image reading apparatus as claimed in claim 1, wherein the scan unit comprises:
a CCD module sensing the image of the document; and
a feed module moving the CCD module in the auxiliary scanning direction of the document.

3. The image reading apparatus as claimed in claim 1, wherein the scanning determination unit comprises:
a guide rail positioned directly below a traveling path of the scan unit;
a movable body coupled to the guide rail so that the movable body moves according to the traveling path of the scan unit;
a positioning rib included in the movable body to be sensed by the home sensor, to determine a point to end scanning in the auxiliary scanning direction of the document; and
a positioning body extending from the movable body and protruding from a portion of the body case.

4. The image reading apparatus as claimed in claim 1, wherein the body case comprises a user selection button to set an operation mode of the scanning determination unit.

5. The image reading apparatus as claimed in claim 3, wherein the positioning body is positioned along the auxiliary scanning direction of the document platen so that a user can set the point to end scanning of the document.

6. The image reading apparatus as claimed in claim 3, wherein the movable body comprises:
a first movable body to predetermine a point to start scanning of the scan unit; and
a second movable body to predetermine a point to end scanning of the scan unit.

7. A document scanning method comprising:
a scanning determination operation of determining a point to end scanning in an auxiliary scanning direction of a document by moving a positioning body of a scanning determination unit corresponding to an actual scanning range of the document seated on a document platen; and
a document scanning operation of scanning the document using a scan unit corresponding to the point to end scanning in the auxiliary scanning direction of the document.

8. The document scanning method as claimed in claim 7, wherein the scanning determination operation comprises an operation of moving a first positioning body of a first movable body and a second positioning body of a second movable body corresponding to the actual scanning range of the document seated on the document platen, to determine a point to start scanning and the point to end scanning in the auxiliary scanning direction of the document.

9. The document scanning method as claimed in claim 7, wherein in the document scanning operation, a point to start scanning in the auxiliary scanning direction of the document is determined based on a point when the scan unit has traveled a predetermined distance from a home position rib.

10. The document scanning method as claimed in claim 7, wherein the scanning determination operation comprises an operation of setting a scanning setting mode with a user selection button.

11. The document scanning method as claimed in claim 7, wherein the scanning determination operation comprises an operation of determining a scanning width in a main scanning direction of the document.

12. The document scanning method as claimed in claim 11, wherein in the operation of determining the scanning width in the main scanning direction of the document, the scanning width of the document is determined in a maximum scanning width in which the scan unit can perform scanning in the main scanning direction of the document.

13. The document scanning method as claimed in claim 11, wherein in the operation of determining the scanning width in the main scanning direction of the document, an edge surface of the document is scanned using the scan unit to determine the scanning width in the main scanning direction of the document.

14. The document scanning method as claimed in claim 13, wherein the scan unit travels within 20 mm from a point to start scanning in the auxiliary scanning direction of the document, to scan the edge surface of the document.

15. An image reading apparatus comprising:
a body case having a document platen;
a scan unit moveably connected with the body case to scan a document positioned on the document platen;
a home sensor connected with the scan unit to detect a home position of the scan unit; and
a scanning determination unit moveably connected with the body case, positioned by a user, and detected by the home sensor to determine a scanning range of the document.

16. The image reading apparatus according to claim 15, wherein the scan unit comprises a CCD module.

17. The image reading apparatus according to claim 15, wherein the body case comprises a home position rib detected by the home sensor and defining the home position of the scan unit.

18. The image reading apparatus according to claim 15, wherein the scanning determination unit comprises:
a guide rail positioned on the body case along a traveling path of the scan unit; and
a movable body moveably coupled with the guide rail, a position of the movable body defining an end of the scanning range along an auxiliary scanning direction of the document.

19. The image reading apparatus according to claim 18, wherein the guide rail comprises a linear bar to slidingly guide the movable body.

20. The image reading apparatus according to claim 18, wherein the movable body comprises:
a positioning body protruding from a portion of the body case and enabling the user to change the position of the movable body; and
a positioning rib, positioned along the traveling path of the scan unit, and detected by the scan unit to define the end of the scanning range along the auxiliary scanning direction of the document.

21. The image reading apparatus according to claim 20, wherein the positioning body comprises:
a handle-shaped prominence enabling the user to manipulate the movable body; and
an indicator to indicate a position of the movable body relative to a scale.

22. The image reading apparatus according to claim 15, further comprising:
a user selection button enabling the user to selectively perform scanning of the document using the scanning determination unit.

23. The image reading apparatus according to claim 15, wherein the scanning determination unit comprises:
a guide rail positioned on the body case along a traveling path of the scan unit;
a first movable body moveably coupled with the guide rail, a position of the movable body defining a start of the scanning range along an auxiliary scanning direction of the document; and
a second movable body moveably coupled with the guide rail, a position of the movable body defining an end of the scanning range along an auxiliary scanning direction of the document.

24. A document scanning method, comprising:
positioning a first positioning body of a scanning determination unit of an image reading apparatus along an auxiliary scanning direction of a document to define an end of a scanning range along the auxiliary scanning direction; and
scanning the document using a scan unit of the image reading apparatus, the scanning ending at the end of the scanning range along the auxiliary scanning direction.

25. The document scanning method according to claim 24, further comprising:
selecting an operation mode of the image reading apparatus; and
determining a scanning width of the document in a main scanning direction of the document,
wherein if a user selects a scanning setting mode, the positioning of the scanning determination unit is performed.

26. The document scanning method according to claim 25, wherein the determining the scanning width of the document in the main scanning direction comprises scanning the document in a maximum scanning width of the scan unit in the main scanning direction.

27. The document scanning method according to claim 25, wherein the determining the scanning width of the document in the main scanning direction comprises moving the scan unit in the auxiliary scanning direction to scan edge surfaces of the document.

28. The document scanning method according to claim 27, wherein a range in which the scan unit moves in the auxiliary scanning direction to scan the edge surfaces of the document is within 20 mm.

29. The document scanning method according to claim 27, wherein the scan unit travels in the auxiliary scanning direction within 20 mm from a start of the scanning range in the auxiliary scanning direction to scan the edge surfaces of the document.

30. The document scanning method according to claim 24, further comprising:
positioning a second positioning body of the scanning determination unit along the auxiliary scanning direction to define a start of the scanning range along the auxiliary scanning direction,
wherein the scanning the document starts at the start of the scanning range along the auxiliary scanning direction.
